(19) United States
(12) Patent Application Publication
(10) Pub. No.: US 2017/0102097 A1
(43) Pub. Date: Apr. 13, 2017

(54) Adjustable Modular Pipe Support Stand

(71) Applicant: Oryx Oilfield Holdings, LLC, Grapevine, TX (US)

(72) Inventors: Travis Lane WALSTON, Seguine, TX (US); Oscar M. GALLARDO, Blue Mound, TX (US); Richard Alan DREW, Grapevine, TX (US)

(21) Appl. No.: 15/132,121

(22) Filed: Apr. 18, 2016

Related U.S. Application Data
(60) Provisional application No. 62/284,869, filed on Oct. 13, 2015.

(51) Int. Cl. F16L 3/00; F16M 11/32; F16M 11/28

(52) U.S. Cl. CPC F16L 3/00; F16M 11/28; F16M 11/32

(57) ABSTRACT

An adjustable modular pipe support stand includes a base, a vertical post having an inner tubing adapted to be inserted into an outer tubing secured to the base, a length of the inner tubing extending outside of the outer tubing being adjustable, and a threaded bolt adapted to be inserted into a threaded opening at a top end of the inner tubing, a length of the threaded bolt extending outside of the inner tubing being adjustable. The pipe support stand further includes a top plate secured to a top end of the threaded bolt and configured to support a pipe.

### RELATED APPLICATION

The present application claims the benefit of U.S. Provisional Patent Application No. 62/284,869 filed on Oct. 13, 2015, and entitled “Modular Pipe Support,” incorporated herein by reference in its entirety.

### FIELD

The present disclosure relates to the field of pipeline construction and maintenance, and in particular to an adjustable modular pipe support stand.

### BACKGROUND

During the construction and installation of a pipeline, it may be desirable to support segments of connected pipes above ground to form an elevated pipeline to transport fluids, such as crude and refined petroleum, oil, natural gas, sewage, slurry, water, etc. During the initial installation, the conventional pipe stand may be manufactured to specific dimensions that may permit a limited ability to adjust the height of the stand to account for ground unevenness and variations. Typically, the height of conventional pipe stands cannot be adjusted after the initial installation has been completed without using special equipment to lift and support the pipeline while changes are being made.

### BRIEF DESCRIPTION OF THE DRAWINGS

FIG. 1 is a perspective view of an exemplary embodiment of an adjustable modular pipe support stand according to the present disclosure;

FIG. 2 is a side view of an exemplary embodiment of an adjustable modular pipe support stand according to the present disclosure;

FIG. 3 is a more detailed view of an exemplary embodiment of a top support plate of the adjustable modular pipe support stand according to the present disclosure;

FIG. 4 is a perspective view of an exemplary embodiment of an adjustable modular pipe support stand with two support posts according to the present disclosure; and

FIG. 5 is a perspective view of an exemplary embodiment of an adjustable modular pipe support stand with three support posts according to the present disclosure.

### DETAILED DESCRIPTION

Oilfield engineers employ many styles of stabilized stands to support numerous types of production equipment. Because each piece of equipment has varying vertical and offset load requirements and different installation elevations, the pipe stands utilized to provide structural support should be durable, customizable, and easy to assemble. In particular, it is desirable to enable customization to allow height modification, both in terms of coarse adjustment as well as fine-tuning to accommodate uneven or soft ground conditions both during initial pipeline installation as well as after installation has been completed. It is also desirable to employ a pipe stand that has a variety of support widths in order to fit a diverse range of pipe sizes and configurations. Because the pipeline and thus the supporting pipe stands are expected to remain in place for many years, an important aspect of pipeline maintenance and service includes addressing pipe stands that have shifted or changed elevation due to weather, settling, erosion, and other natural forces.

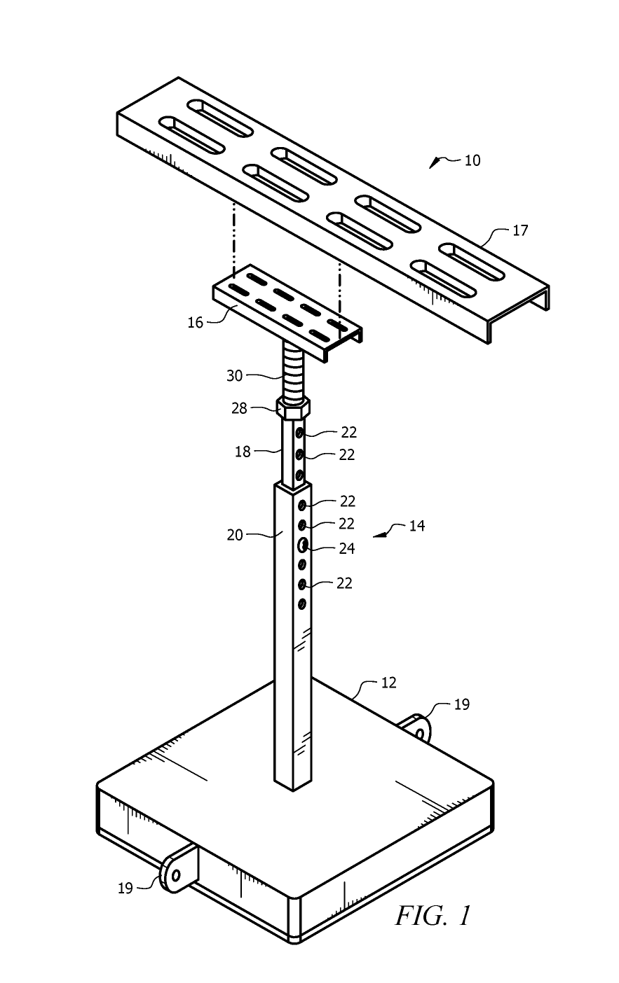

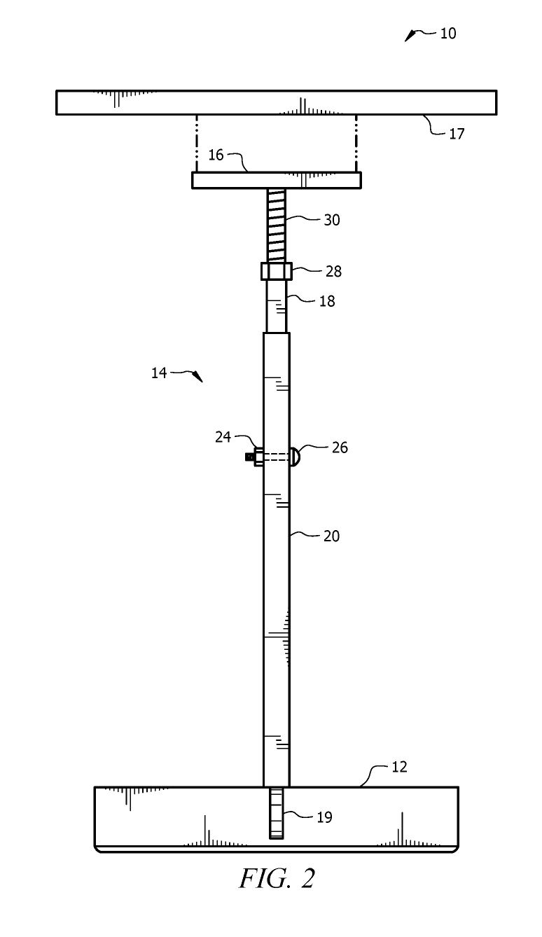

FIG. 1 is a perspective view of an exemplary embodiment of an adjustable modular pipe support stand 10 according to the present disclosure. The modular pipe support stand 10 includes a base 12 with a vertical post 14 and a top support plate 16. The top support plate 16 may be constructed of a flat steel plate or a slotted C-channel as shown. A load-bearing C-channel 17 may further be fastened or secured atop the top plate 16. The base 12 preferably has a six-sided construction that has broad top and bottom surfaces to provide a sturdy foundation for the stand 10. Alternatively, the base 12 may be constructed of a heavy steel plate or a concrete pad or foundation. The top and bottom surfaces of the base 12 are square in shape in the example shown in FIG. 1. Two lifting eyes 19 are firmly affixed to opposing sides of the base 12. The vertical post 14 of the stand 10 is firmly secured to the center of the base 12, and includes a length of a first square tubing 18 with smaller cross-sectional dimensions inserted within a length of a second square tubing 20 with larger cross-sectional dimensions. The second square tubing 20 thus acts as a sleeve outside of the smaller square tubing 18, where the smaller or inner square tubing 18 can extend in and out of the larger or outer square tubing 20, changing the effective total length of the vertical post 14. The two segments 18 and 20 of square tubing further include a plurality of spaced-apart through holes 22. The through holes 22 in both square tubing are identically or closely matched in size and spacing. Better seen in FIG. 2, a fastener 26 such as a pin, rod, bolt, or threaded stud bolt can be inserted through both lengths of square tubing 18 and 20 using the through holes 22 and secured with a threaded nut 24, thus effectively restricting the amount of tubing 18 that extend out of tubing 20, and fixing the effective length or height of the vertical post 14. The adjustability of the effective combined length of the square tubing 18 and 20 gives rise to a coarse adjustment capability to the modular pipe support stand 10.

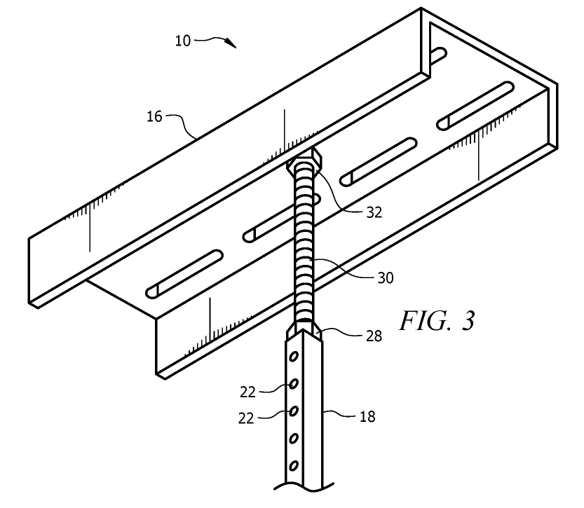

As better shown in FIGS. 2 and 3, a threaded nut 28 is secured to the top opening of the inner square tubing 18. The inner square tubing 18 and threaded nut 28 thus define a threaded opening at the top end of the vertical post 14 that may accommodate a threaded stud bolt 30. The threaded stud bolt 30 may be secured to the top support plate 16 via a threaded nut 32 fastened to the underside of the top support plate 16. The threaded nut 28 may be rotated so that the threaded stud bolt 30 advances into or retreats from the inner square tubing 18, and effectively changing the overall length of the vertical post 14. Therefore, the threaded action of the threaded stud bolt 20 and threaded nut 28 give rise to a fine adjustment capability to the modular pipe support stand 10.

The adjustable modular pipe support stand 10 has a modular construction that can be easily assembled and modified at installation. The final height of the stand 10 may be easily adjusted with the coarse and fine adjustment mechanisms described above to account for variable elevation and ground conditions in the field. The pipeline is typically fastened to the load-bearing C-channel using a variety of fasteners such as U bolts, for example. After the initial installation of the pipeline, the height of the adjustable modular pipe support stand 10 can be easily adjusted without special equipment or disassembly to address altered ground elevation. In most cases, the height can be adjusted without heavy lift equipment to support the production equipment. The adjustable modular pipe support stand concept may also be expanded to a range of dimensions to accommodate a large spectrum of pipe sizes, loads, and elevation requirements. Further, each stand may be easily modified to support more than one pipeline.

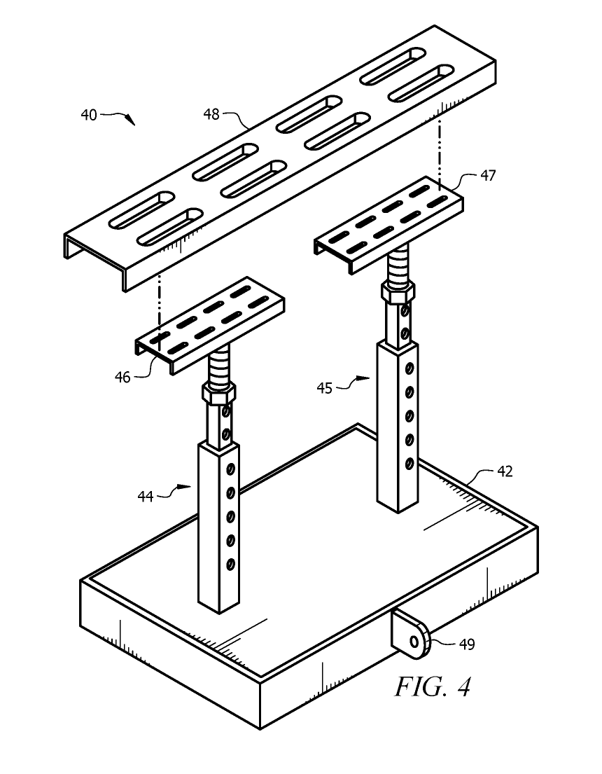

FIG. 4 is a perspective view of an exemplary embodiment of an adjustable modular pipe support stand 40 with two support posts according to the present disclosure. The pipe support stand 40 includes a generally rectangular base 42 with two spaced apart vertical posts 44 and 45 with the same coarse and fine adjustment mechanisms described above. Top plates 46 and 47 are secured to the vertical posts 44 and 45, respectively, in the same manner described above. A load-bearing C-channel 48 is further fastened or secured atop the top plates 46 and 47. The base 42 further includes lifting eyes 49.

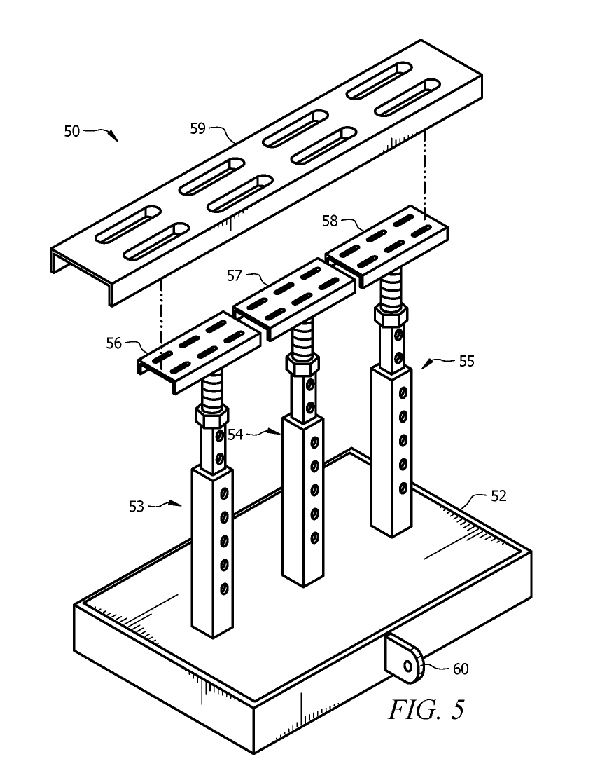

FIG. 5 is a perspective view of an exemplary embodiment of an adjustable modular pipe support stand 50 with three support posts according to the present disclosure. The pipe support stand 50 includes a generally rectangular base 52 with three spaced apart vertical posts 53-55 with the same coarse and fine adjustment mechanisms described above. Top plates 56-58 are secured to the vertical posts 53-55, respectively, in the same manner described above. A load-bearing C-channel 59 is further fastened or secured atop the top plates 56-58. The base 52 further includes lifting eyes 60.

The adjustable modular pipe support stand assembles easily without specialty tools or complicated instructions. The entire stand can be assembled and adjusted to the requisite height using coarse and fine adjustments without the need for cutting equipment. The components are heavy-duty in composition and standardized allowing for compact storage and efficient loading for travel or transport. The adjustable modular pipe support stand can support a great amount of weight, and with the addition of multiple vertical posts, the loading capacities can be significantly increased. The stand components are preferably made of heavy-duty steel that are sandblasted, primed, and painted to protect from adverse effects of the environment and weather. Unlike conventional pipe stands, the height of the adjustable modular pipe support stand may be easily modified by using the coarse and fine adjustment mechanisms without disassembly or using special lift equipment.

It should also be understood that the adjustable modular support stand may be used in various construction, facilities, and other industries to support heavy loads where it is desirable to provide the capability of coarse and/or fine height adjustment, onsite, before, during, or after the initial installation.

It should be noted that variations may be made to the components without departing significantly from the main concept of the adjustable modular pipe support stand. For example, the vertical posts may be constructed of circular pipes rather than square tubing. The shape of the base may be square, rectangular, triangular, round, or any suitable shape as long as it provides a stable foundation for the stand. As another example, the top support plate may be substituted with a flat plate or C-shaped cradle that coincide with the radius of the pipe to be supported.

The features of the present invention which are believed to be novel are set forth below with particularity in the appended claims. However, modifications, variations, and changes to the exemplary embodiments described above will be apparent to those skilled in the art, and the adjustable modular pipe support stand described herein thus encompasses such modifications, variations, and changes and are not limited to the specific embodiments described herein.

What is claimed is:

1. An adjustable modular support stand comprising:
a base;
a vertical post having an inner tubing adapted to be inserted into an outer tubing secured to the base, a length of the inner tubing extending outside of the outer tubing being adjustable, and a threaded bolt adapted to be inserted into a threaded opening at a top end of the inner tubing, a length of the threaded bolt extending outside of the inner tubing being adjustable; and
a top plate secured to a top end of the threaded bolt and configured to support a load.

2. The adjustable modular support stand of claim 1, wherein the inner tubing has a first series of spaced through holes along its length, and the outer tubing has a second series of spaced through holes along its length, the size and spacing of the first and second series of through holes being compatible to permit a fastener to be inserted to selectively fix the length of the inner tubing extending outside of the outer tubing.

3. The adjustable modular support stand of claim 2, wherein the bolt is a threaded bolt and a threaded nut is used to secure the threaded bolt in the through holes of the inner and outer tubing.

4. The adjustable modular support stand of claim 1, further comprising a load-bearing C-channel securely fastened to the top plate and sized to support the load.

5. The adjustable modular support stand of claim 1, further comprising at least two vertical posts.

6. The adjustable modular support stand of claim 1, wherein the base further comprises a pair of lifting eyes.

7. The adjustable modular support stand of claim 1, wherein the base is constructed of a material selected from the group consisting of metal and concrete.

8. A modular stand for a pipeline comprising:
a vertical post having an inner tubing adapted to be inserted into an outer tubing adapted to be secured to a base, a length of the inner tubing extending outside of the outer tubing being adjustable, and a threaded stud bolt adapted to be inserted into a threaded opening at a top end of the inner tubing, a length of the threaded stud bolt extending outside of the inner tubing being adjustable;
a horizontal top plate secured to a top end of the threaded stud bolt; and
a load-bearing C-channel securely fastened to the top plate and sized to support a segment of the pipeline.

9. The modular stand of claim 8, wherein the inner tubing has a first series of spaced through holes along its length, and the outer tubing has a second series of spaced through holes along its length, the size and spacing of the first and second series of through holes being compatible to permit the threaded stud bolt to be inserted to temporarily fix the length of the inner tubing extending outside of the outer tubing.

10. The modular stand of claim 9, wherein the threaded stud bolt is secured in the through holes of the inner and outer tubing with a threaded nut.

11. The modular stand of claim 8, further comprising at least two vertical posts.

12. The modular stand of claim 8, further comprising a base with a pair of lifting eyes.

13. The adjustable modular support stand of claim 8, wherein the base is constructed of a material selected from the group consisting of metal and concrete.

14. An adjustable modular pipe support stand comprising:
a base;
a vertical post adapted to be secured to the base, the vertical post having a coarse length adjustment mechanism and a fine length adjustment mechanism, the vertical post having an effective length that may be temporarily fixed at installation and thereafter adjusted post-installation by the coarse and fine length adjustment mechanisms;
a top plate secured to a top end of the vertical post; and
a load-bearing plate configured to be fastened atop the top plate and configured to support a pipe.

15. The adjustable modular pipe support stand of claim 14, wherein the vertical post comprises an inner tubing adapted to be inserted into an outer tubing that may be firmly secured to the base, a length of the inner tubing extending outside of the outer tubing being adjustable, and a threaded bolt adapted to be inserted into a threaded opening at a top end of the inner tubing, a length of the threaded bolt extending outside of the inner tubing being adjustable.

16. The adjustable modular pipe support stand of claim 15, wherein the inner tubing has a first series of spaced through holes along its length, and the outer tubing has a second series of spaced through holes along its length, the size and spacing of the first and second series of through holes being compatible to permit a threaded bolt to be inserted to selectively fix the length of the inner tubing extending outside of the outer tubing.

17. The adjustable modular pipe support stand of claim 16, further comprising a threaded nut to secure the threaded bolt in the through holes of the inner and outer tubing.

18. The adjustable modular pipe support stand of claim 14, further comprising at least two vertical posts.

19. The adjustable modular pipe support stand of claim 14, wherein the base further comprises a pair of lifting eyes.

20. The adjustable modular support stand of claim 14, wherein the base is constructed of a material selected from the group consisting of metal and concrete.
